(19) United States
(12) Patent Application Publication
(10) Pub. No.: US 2026/0159311 A1
(43) Pub. Date: Jun. 11, 2026

(54) Trash Container Cover Control System and Method Thereof

(71) Applicant: Nine Stars (U.S.A.) Inc., Ontario, CA (US)

(72) Inventors: Shi Ping Wang, Ontario, CA (US); Jiangqun Chen, Fuzhou (CN); Zhou Lin, Fuzhou (CN)

(73) Assignee: Nine Stars (U.S.A.) Inc., Ontario, CA (US)

(21) Appl. No.: 18/972,828

(22) Filed: Dec. 6, 2024

(51) Int. Cl. B65F 1/16; E05F 15/43

(52) U.S. Cl. CPC B65F 1/1638; E05F 15/43; B65F 2210/168; E05Y 2900/20

(57) ABSTRACT

A trash container cover control system and method thereof are provided, wherein during a container cover closing process, an infrared pulse signal is emitted by an infrared pulse testing circuit to the detecting zone for every 10 ms to 300 ms. Each emitting of the infrared pulse signal is maintained for smaller or equal to 0.3 ms, during which a power supply to the motor of the induction trash container is temporarily stopped by a motor driving circuit, wherein if an object is detected in the detecting zone, a reverse voltage is applied to the motor to rotate in an opposite direction to drive the container cover to re-open immediately for a predetermined period of time, and if no object is detected, the power supply is restored to apply the positive voltage to the motor to continue to close the container cover in place.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to induction trash container, and more particularly to a trash container cover control system and method thereof for controlling an automatic re-opening process during a closing process of a container cover of an induction trash container.

### Description of Related Arts

Most of the conventional induction trash containers utilize infrared ray reflection technology as the sensor to control the opening and closing of the container cover of the induction trash container. During the operation, most users expect the container cover being opened as fast as possible and closed in a relatively slow manner. It is because, the faster the container cover being opened, the more convenient for the users to promptly discard the trash in his or her hands. Also, if the speed of closing the container cover is too fast, the container cover is easy to touch the user's hand during the closing action. Therefore, the container cover is preferred to be closing slowly so as to prevent the closing container cover contacting and contaminating the user' hands and avoid the loud collision noise of the container cover and trash container body. A rapid closing of the container cover may hit the user's hand and cause injury while the user is attempting to throw more trash during the container cover closing process. It is preferred that, during the container cover closing process, if the user wants to throw trash again, the user has to wait until the container cover is closed in place before he or she can open the container cover by induction and throw the trash again.

In order to solve the above problem, one may consider to continuously emit infrared pulse signal to the detecting zone to detect whether there is an object in the detecting zone during the container cover closing process so that when an object is detected, the induction trash can re-open the container cover again without the need to wait until the container cover being closed in place. However, because the motor of the induction trash container is in an energized state during the container cover closing process, the motor in the energized state would produce strong interference with the infrared pulse test circuit with weak signal amplification, that adversely affects the infrared pulse test circuit to work normally and thus fails to solve the above problem practically.

On the other hand, most induction trash containers use one or more batteries as power supply for emitting infrared pulse signals and powering the motor to open and close the container cover. No matter the battery is rechargeable or not, how to save power consumption to prolong the life span of the battery is always a desire in the industry.

### SUMMARY OF THE PRESENT INVENTION

An advantageous of the present invention is to provide a trash container cover control system and method thereof, which allows the container cover of the induction trash can to be re-opened again during the container cover closing process without strong interference with the weak signal amplification of the infrared pulse test circuit.

Another advantageous of the present invention is to provide a trash container cover control system and method thereof, wherein the container cover can be re-opened anytime during the closing action of the container cover. In other words, before the container cover is completely closed in place, the user may induce the induction trash container to open the container cover in a rapid and smooth manner.

Another advantageous of the present invention is to provide a trash container cover control system and method thereof, wherein the induction trash can is maintained in a continuous detection state for detecting any object within the detecting zone during the closing action of the container cover thereof, without affecting the continuity and smoothness of the container cover closing process.

Another advantageous of the present invention is to provide a trash container cover control system and method thereof for an induction trash container, which specifically facilitate users need to discard trashes from time to time such as working in a kitchen, wherein a sufficient time delay is provided for discarding trashes into the induction trash container when the container cover is induced to open again during the container cover closing process through a reflective infrared pulse testing circuit activated by an object such as a hand within the detecting zone of the induction trash container, so as to reduce the risk of cross-contaminating and hitting the user's hands by immediately re-opening the container cover rapidly during the container cover closing process once the user's hand is detected within the detecting zone of the induction trash container.

Another advantageous of the invention is to provide a trash container cover control system and method thereof for an induction trash container, which provide a continuous and smooth operation of the container cover closing process.

Another advantageous of the invention is to provide a trash container cover control system and method thereof for an induction trash container which significantly reduces the power consumption of the one or more batteries equipped in the induction trash container.

Additional advantageous and features of the invention will become apparent from the description which follows and may be realized by means of the instrumentalities and combinations particular point out in the appended claims.

According to the present invention, the foregoing and other objects and advantages are attained by a method of reopening a container cover of an induction trash container during a container cover closing process, comprising steps of:
emitting infrared pulse signals intervally to a detecting zone of the induction trash container to detect whether there is an object presence in the detecting zone, and
reopening the container cover of the induction trash container during the container cover closing process by actuating a motor of the induction trash container to reverse a rotation direction thereof to open the container cover once an object is detected within the detecting zone.

According to a preferred embodiment of the present invention, a trash container cover control method of an induction trash container is provided, wherein the induction trash container comprises a container body, a container cover configured to be selectively operated between a close state and an open state with respect to the container body, a control system which includes an infrared pulse testing circuit, a microcomputer controller, a motor, a motor driving circuit, and a speed reducer, wherein when an object is detected in a predetermined detecting zone by the infrared pulse testing circuit, the container cover is actuated to a container cover opening process to open the container cover to an open state with respect to the container body by the motor, the motor driving circuit and the speed reducer, wherein after a first predetermined period of time, the container cover in open state is activated to a container cover closing process by the motor, the motor driving circuit and the speed reducer until the container cover is completely closed to a close state with respect to the trash container within a second predetermined period of time (such as 3 second (3000 ms)),
the trash container cover control method, which is adapted to re-open the container cover during a container cover closing process of the induction trash container, comprising steps of:
(a) during the container cover closing process, applying a positive voltage to the motor to drive the motor to rotate forward to drive the container cover to begin a container cover closing action to close;
(b) emitting an infrared pulse signal by the infrared pulse testing circuit to the detecting zone for every first predetermined interval of time (such as every 10 ms to 300 ms) by controlling the infrared pulse testing circuit by the microcomputer controller;
(c) maintaining each emitting of the infrared pulse signal for a second predetermined interval of time (such as smaller or equal to 0.3 ms);
(d) temporarily stopping a power supply to the motor by the motor driving circuit controlled by the microcomputer controller during the second predetermined interval of time;
(e) if no object is detected in the detecting zone during the second predetermined interval of time, restoring the applying of the positive voltage to the motor by the motor driving circuit to drive the motor to rotate to drive the container cover to continue to complete the container cover closing action thereof until the container cover is in the close state;
(f) if an object is detected in the detecting zone during the second predetermined interval of time, applying a reverse voltage to the motor, to rotate in an opposite direction, to drive the container cover to re-open immediately to the open state; and
(g) after the first predetermined period of time, if no object is detected, repeating the steps (a) to (e) to close the trash container cover.

According to the above control method, during the closing process of the container cover of the induction trash container, the infrared pulse test circuit is controlled by the microcomputer controller to emit the infrared pulse signal to the detecting zone at every first predetermined interval of time (or every interval of a total closing stroke of the container cover in an alternative mode). If no object is detected in the detecting zone, the microcomputer controller controls the motor to rotate in one direction to drive the container cover to continue to complete the closing action through the motor drive circuit. If there is an object detected in the detecting zone, the microcomputer controller controls the motor to rotate in a reverse direction through the motor drive circuit, so that the container cover is opened immediately. During each duration of the second predetermined interval of time that the infrared pulse signal is emitted to the detecting zone, the power supply to the motor is temporarily stopped, and the power supply to the motor is restored immediately after the infrared pulse signal after the second predetermined interval of time of the emitting of the infrared pulse signal is completed, wherein during the container cover closing process, a cumulative emission of infrared pulse signals to the detecting zone is much less than the time of the container cover closing process.

In one embodiment, during the container cover closing process, every first predetermined interval of time is set to 10 ms to 300 ms and the second predetermined interval of time is smaller or equal to 0.3 ms. In other words, the infrared pulse signal is emitted to the detecting zone every 10 ms to 300 ms and each duration of the emitting of the infrared pulse signal to the detecting zone (i.e. the second predetermined interval of time) is less than or equal to 0.3 ms.

In one embodiment, the second predetermined period of time is about 2 to 5 seconds. For example, setting the second predetermined period of time for closing the container cover is 4 seconds (4000 ms), the second predetermined interval of time for each emitting of the infrared pulse signal to the detecting zone is 0.3 ms, and each first predetermined interval of time between two emitting of the infrared pulse signal to the detecting zone is 10 ms according to a minimum interval time. Then, during the second predetermined period of time, 4000 ms, of the closing action of the container cover, a total of 400 infrared pulse signals are emitted to the detecting zone intervally and a cumulative time of emitting infrared pulse signals to the detecting zone=400 times×0.3 ms=120 ms. Accordingly, a cumulative stop time of the motor of 120 ms is much less than the second predetermined period of time, 4000 ms, of the slow container cover closing process of the container cover. However, the motor stop time of each cycle is 0.3 ms, an energized duty cycle of the motor=10 ms÷(10 ms+0.3 ms)=97%. Therefore, the high duty cycle of the motor is energized, and since the rotor of the motor, the container cover and the speed reducer are elements with weight inertia, there is almost no mechanical inertial effect of the container cover closing process so as to ensure the continuity and smoothness of the container cover closing process.

In one embodiment, during the container cover closing process, an infrared pulse signal is emitted to the detecting zone for every 0.5%˜10% interval of a total closing stroke of the closing container cover in the container cover closing process, from fully open to completely close, and then an interval of time for each emitting of the infrared pulse signal to the detecting zone is less than or equal to 0.3 ms. For example, setting the second predetermined period of time for closing the container cover is 3 seconds (3000 ms) and the interval of time for each emitting of the infrared pulse signal to the detecting zone is 0.3 ms, the infrared pulse signal is emitted once every 0.5% of the total closing stroke of the closing container cover in the container cover closing process. Accordingly, during a total closing stroke of the container cover, 200 times of infrared pulse signal are emitted to the detecting zone, and thus a cumulative time of the emitting of the infrared pulse signal to the detecting zone=200 times×0.3 ms=60 ms. Therefore, a cumulative stopping time of the motor, 60 ms, is much less than the time of 3000 ms in the slow container cover closing process of the container cover, and a total duty cycle of the motor=(3000 ms−60 ms)÷3000 ms=98%, wherein the high duty cycle of the motor is energized, and since the rotor of the motor, the container cover and the speed reducer are elements with weight inertia, there is almost no mechanical inertial effect of the container cover closing process so as to ensure the continuity and smoothness of the container cover closing process.

Compared with the conventional art, the present invention achieves the following advantages:
(1) In the slow closing process of the container cover, the infrared pulse signal is continuously emitted to the detecting zone that, when a human hand or an object re-enters the detecting zone, the container cover does not need to wait until it is closed in place to re-open, that significantly overcomes the shortcoming of the interference of the infrared pulse test circuit when the motor is energized in the conventional art while achieving the function of allowing re-throwing of trash during the container cover closing process by re-opening the container cover once an object is detected in the detecting zone during the container cover closing process. At the same time, the problem that it is easy to touch the human hand during the container cover closing action is overcome, and that it also ensures continuity and smoothness during the slow closing action of the container cover.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a schematic view illustrating a trash container cover control system of an induction trash container according to a preferred embodiment of the present invention.

FIG. 2 is block diagram illustrating a trash container cover control method according to the above preferred embodiment of the present invention.

FIG. 3 is a pulse diagram illustrating a pulse rectangular waveform of closing the container cover according to the above preferred embodiment of the present invention.

FIG. 4A is a perspective view of the induction trash container equipped with the trash container cover control system according to the above preferred embodiment of the present invention, wherein the container cover is in close state.

FIG. 4B is a perspective of a container cover device of the induction trash container according to the above preferred embodiment of the present invention, wherein the container cover is in open state.

FIG. 4C is a partial exploded view illustrating components of the container cover device according to the above preferred embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

In the description of the present invention, unless explicitly stated otherwise and qualified, terms such as “coupled’ and “attached” should be construed broadly. For instance, these terms may indicate a permanent connection or a detachable one, or they may refer to a whole unit. They can signify a mechanical linkage, an electrical connection, direct coupling, or indirect interaction through an intermediary medium. Whether these terms imply an internal connection between two elements or an interactive relationship between them will depend on the specific context and the understanding of those skilled in the art.

Throughout this invention, unless explicitly stated otherwise and qualified, when the first feature is described as being “upper” or “lower” the second feature, this may entail direct physical contact between the two features. Alternatively, it may signify that the first and second features are not in direct contact but are linked through the involvement of additional features.

In this embodiment's description, terms such as “forward” and “reverse” are used to describe orientations or positional relationships. These descriptions are based on the orientations or positions depicted in the drawings and are employed for ease of explanation and simplification of operation. They should not be construed as indications or implications that the device or element being discussed must possess a specific orientation, be constructed in a particular manner, or operate exclusively in a certain orientation. Furthermore, terms such as “first” and “second” are employed solely for the purpose of distinction in the description and do not carry any particular significance.

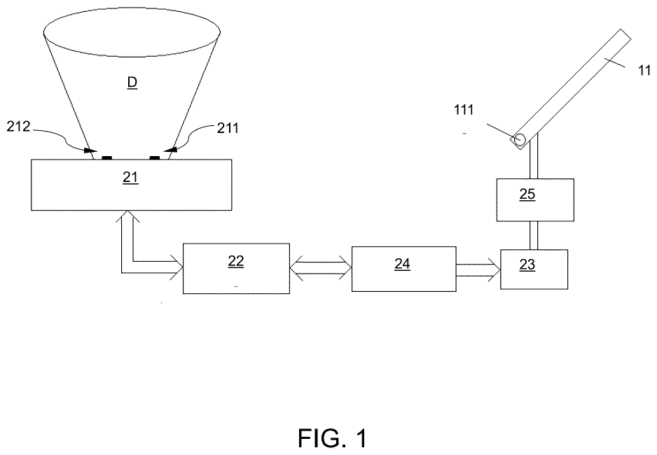

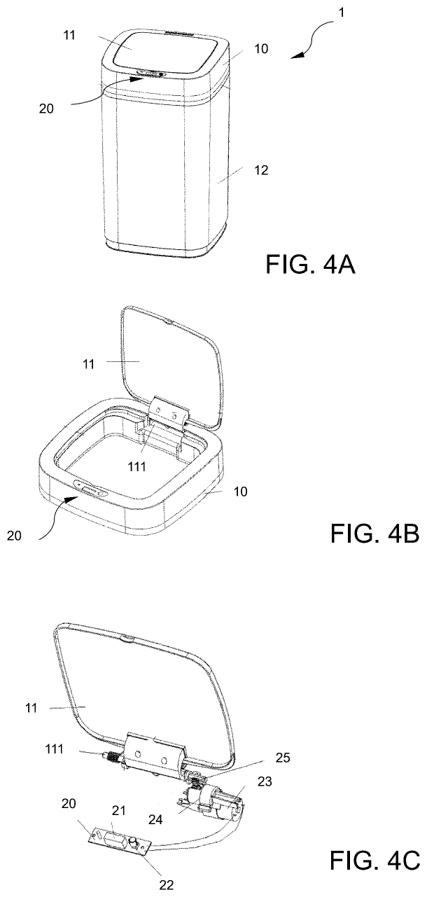

Referring to FIG. 1 to FIG. 4C of the drawings, a trash container cover control system and method thereof for an induction trash container according to a preferred embodiment of the present invention are illustrated. The induction trash container 1 comprises a container cover device 10, mounted on a container body 12, comprising a container cover 11 configured to be selectively operated between an open state, that an inner cavity of the container body 12 is opened to communicate with outside as shown in FIG. 4B, and a close state that the container cover 11 closes the inner cavity of the container body 12 from outside as shown in FIG. 4A. The induction trash container 1 further comprises a control system 20 which includes an infrared pulse testing circuit 21, a microcomputer controller 22, a motor 23, a motor driving circuit 24, and a speed reducer 25.

Referring to FIG. 1 and FIG. 4A to FIG. 4C, the infrared pulse testing circuit 21 comprises an infrared pulse emitter 211 configured to emit infrared pulse signals into a detecting zone D and an infrared pulse receiver 212 configured to receive reflecting infrared pulse signals reflected by an object in the detecting zone D. The microcomputer controller 22 is configured to electrically connected with the infrared pulse testing circuit 21 and the motor driving circuit 24 for controlling the operations of the infrared pulse testing circuit 21 and the motor driving circuit 24. The motor driving circuit 24 is configured to electrically connected to the motor 23 for applying a positive voltage to the motor 23 to drive the motor 23 to rotate in a forward direction and a reverse voltage to the motor 23 to drive the motor 23 to rotate in an opposite direction. The speed reducer 25 is configured to couple with an output shaft of the motor 23 so as to reduce a rotation speed of the motor 23 to drive a pivot shaft 111 connecting to the container cover 11 so as to rotate to drive the container cover 11 to rotate downwards about the pivot shaft 111 to a close state, as shown in FIG. 4A, to close a receiving chamber of the container body 12 from outside or to rotate upwards about the pivot shaft 111 to an open state, as shown in FIG. 4B, to open the receiving chamber of the container body 12 to communicate with outside for the user to discard trash into the receiving chamber of the container body 12.

According to the present invention, the trash container cover control system 20 is arranged in the induction trash container 1 to perform a method of reopening the container cover 11 during the container cover closing process through the following steps:
emitting the infrared pulse signals intervally to the detecting zone D of the induction trash container 1 to detect whether there is an object presence in the detecting zone D; and
actuating the motor 23 of the induction trash container 1 to reverse a rotation direction thereof to open the container cover 11 once an object is detected within the detecting zone D.

In other words, the trash container cover control method is adapted to re-opening the container cover 11 during the container cover closing process of the induction trash container 1.

According to the preferred embodiment of the present invention, the trash container cover control system 20 is configured to perform a trash container cover control method during the container cover closing process of the trash container cover 11, from the open state to the close state, after the trash container cover 11 being opened for the first predetermined period of time, wherein the method comprises the following steps:
(a) during the container cover closing process, applying the positive voltage to the motor 23 to drive the motor 23 to rotate forward to drive the container cover 11 to begin a container cover closing action to close through the speed reducer 25;
(b) emitting the infrared pulse signal by the infrared pulse testing circuit 21 to the detecting zone D for every first predetermined interval of time by controlling the infrared pulse testing circuit 21 by the microcomputer controller 22;
(c) maintaining each emitting of the infrared pulse signal for a second predetermined interval of time;
(d) temporarily stopping a power supply to the motor 23 by the motor driving circuit 24 controlled by the microcomputer controller 22 during the second predetermined interval of time;
(e) if no object is detected in the detecting zone D during the second predetermined interval of time, restoring the applying of the positive voltage to the motor 23 by the motor driving circuit 24 to drive the motor 23 to rotate to drive the container cover 11 to continue to complete the container cover closing action thereof until the container cover 11 is in the close state;
(f) if an object is detected in the detecting zone D during the second predetermined interval of time, applying the reverse voltage to the motor 23, to rotate in the opposite direction, through the speed reducer 25, to drive the container cover 11 to re-open immediately to the open state; and
(g) after the first predetermined period of time, if no object is detected, repeating the steps (a) to (e) to close the trash container cover 11.

In other words, the infrared pulse testing circuit 21 is configured to emit the infrared pulse signal and receive reflected infrared pulse signal in the detecting zone D. When an object is detected in the detecting zone D by the infrared pulse testing circuit 21, the microcomputer controller 22 is configured to activate the motor driving circuit 24 to apply a reverse voltage to the motor 23 to drive the motor 23 to rotate in the opposite direction to actuate o a container covering opening process to open the container cover 11 to the open state with respect to the container body 12 for a first predetermined period of time. After the first predetermined period of time, the microcomputer controller 22 controls the motor driving circuit 24 to apply the positive voltage to the motor 23 to drive the motor 23 to rotate in a forward direction to actuate the container cover 11 to a container cover closing process to close the container cover 11 to the close state with respect to the container body 12.

According to the present invention, the infrared pulse testing circuit 21 is controlled by the microcomputer controller 22 to emit an infrared pulse signal to the detecting zone during the container cover closing process for every first predetermined interval of time, preferably every 10 ms to 300 ms, wherein each of the emitting of the infrared pulse signal is maintained for a second predetermined interval of time, preferably smaller or equal to 0.3 ms. The microcomputer controller 22 also controls the motor driving circuit 24 to temporarily stop the power supply to the motor 23 during the second predetermined interval of time.

During the second predetermined interval of time, if an object is detected in the detecting zone D, the motor driving circuit 24 is controlled by the microcomputer controller 22 to apply the reverse voltage to the motor 23 to rotate in the opposite direction to drive the container cover 11 to re-open immediately for the first predetermined period of time. Thereafter, the microcomputer controller 22 controls the motor driving circuit 24 to perform the container cover closing process by applying the positive voltage to the motor 23 to drive the motor 23 to rotate in the forward direction to close the container cover 11 with respect to the container body 12.

If no object is detected in the detecting zone D during the second predetermined interval of time, the motor driving circuit 24 is controlled by the microcomputer controller 22 to apply the positive voltage to the motor 23 to drive the motor 23 to rotate in the forward direction to drive the container cover 11 to continue to complete the container cover closing action thereof until the container cover 11 is closed in the close state.

According to the preferred embodiment of the present invention, during the container cover closing process, every first predetermined interval of time is set to 10 ms to 300 ms and the second predetermined interval of time is smaller or equal to 0.3 ms. In other words, the infrared pulse signal is emitted to the detecting zone D every 10 ms to 300 ms and each duration of the emitting of the infrared pulse signal to the detecting zone D (i.e. the second predetermined interval of time) is less than or equal to 0.3 ms. Also, the second predetermined period of time is about 2 to 5 seconds, for example 3 seconds (3000 ms).

In other words, according to the preferred embodiment, when the container cover 11 enters the container cover closing process, at first, the motor drive circuit 24 is controlled by the microcomputer controller 22 to apply the positive voltage to the motor 23, the motor 23 rotates in the forward direction, and then the container cover 11 is driven to rotate clockwise with the pivot shaft 111 as a center by the deceleration of the speed reducer 25 and the container cover 11 begins to enter the closing action. Then, the infrared pulse testing circuit 21 is controlled by the microcomputer controller 22 to send an infrared pulse signal to the detecting zone D at every interval of 50 ms (the first predetermined interval of time) for an interval of 0.3 ms (the second predetermined interval of time), during which the power supply to the motor 23 is temporarily stopped by the motor driving circuit 24 controlled by the microcomputer controller 22. If no object is detected in the detecting zone D, the microcomputer controller 22 restores to apply the positive voltage to the motor 23 by the motor driving circuit 24, and the forward rotation of the motor 23 drives the container cover 11 to continue to complete the container cover closing action. If an object is detected in the detecting zone D during the interval of 0.3 ms, an internal program of the microcomputer controller 22 is transferred to a cover opening program, wherein the microcomputer controller 22 controls the motor drive circuit 24 to apply the reverse voltage to the motor 23, and the motor 23 rotates in the opposite direction, through the deceleration of the speed reducer 25, to drive the container cover 11 to pivotally rotate upwards about the pivot shaft 111 so that the container cover 11 is opened immediately.

According to the present invention, the high duty cycle of the motor 23 is energized and, since the rotor of the motor 23, the container cover 11 and the speed reducer 25 are elements with weight inertia, there is almost no mechanical inertial effect of the container cover closing process so as to ensure the continuity and smoothness of the container cover closing process. For example, setting the second predetermined period of time for closing the container cover 11 is 4 seconds (4000 ms), the second predetermined interval of time for each emitting of the infrared pulse signal to the detecting zone D is 0.3 ms, and each first predetermined interval of time between two emitting of the infrared pulse signal to the detecting zone D is 10 ms according to a minimum interval time. Then, during the second predetermined period of time, 4000 ms, of the closing action of the container cover 11, a total of 400 infrared pulse signals are emitted to the detecting zone D intervally and a cumulative time of emitting infrared pulse signals to the detecting zone D=400 times×0.3 ms=120 ms. Accordingly, a cumulative stop time of the motor 23 of 120 ms is much less than the second predetermined period of time, 4000 ms, of the slow container cover closing process of the container cover 11. Therefore, the motor stop time of each cycle is 0.3 ms, an energized duty cycle of the motor 23 is high as 10 ms÷(10 ms+0.3 ms)=97%.

According to an alternative mode of the preferred embodiment of the present invention, during the container cover closing process, the infrared pulse signal can be emitted to the detecting zone D for every 0.5%˜10% interval of a total closing stroke of the closing container cover 11 in the container cover closing process, from fully open to completely close, instead of the first predetermined interval of time. Also, an interval of time for each emitting of the infrared pulse signal to the detecting zone D is less than or equal to 0.3 ms. For example, setting the second predetermined period of time for closing the container cover 11 is 3 seconds (3000 ms) and the interval of time for each emitting of the infrared pulse signal to the detecting zone D is 0.3 ms, the infrared pulse signal is emitted once every 0.5% of the total closing stroke as a minimum stroke interval. Accordingly, during the total closing stroke of the container cover 11, 200 times of infrared pulse signal are emitted to the detecting zone D, and thus a cumulative time of the emitting of the infrared pulse signal to the detecting zone D=200 times×0.3 ms=60 ms. Therefore, a cumulative stopping time of the motor 23, 60 ms, is much less than the time of 3000 ms in the slow container cover closing process of the container cover 11, and a total duty cycle of the motor 23 is as high as (3000 ms−60 ms)÷3000 ms=98%. Accordingly, the high duty cycle of the motor 23 is energized and, since the rotor of the motor 23, the container cover 11 and the speed reducer 25 are elements with weight inertia, there is almost no mechanical inertial effect of the container cover closing process so as to ensure the continuity and smoothness of the container cover closing process.

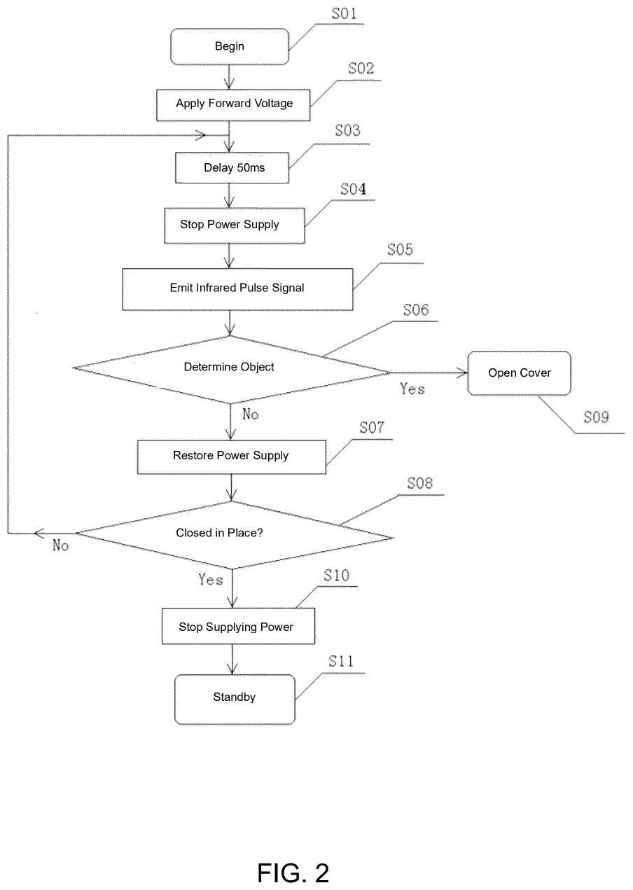

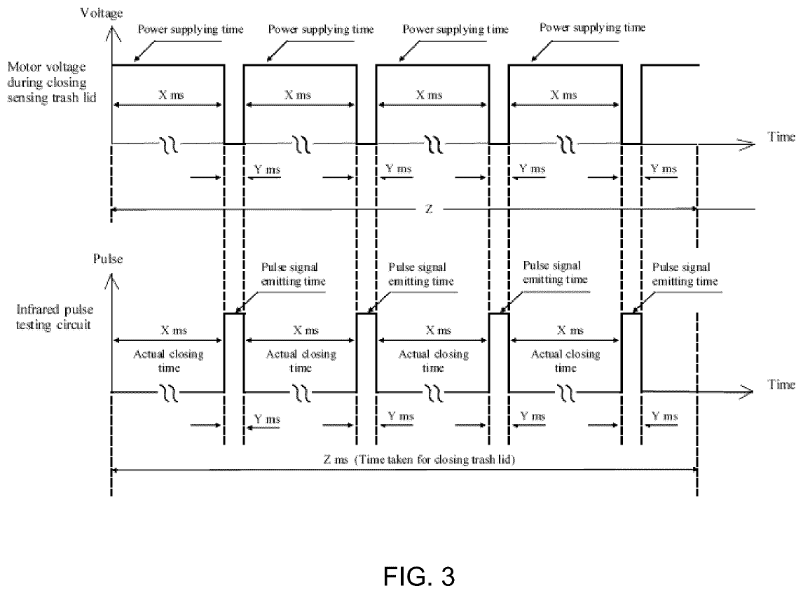

Referring to FIG. 2 and FIG. 3, the container cover closing process of the microcomputer controller 22 for the container cover 11 is illustrated, which includes the following steps:
Step S01: Begin the container cover closing process of the container cover 11.
Step S02: The microcomputer controller 22 controls the motor driving circuit 24 to apply the positive (forward) voltage to the motor 23, and the container cover closing process goes to the Step S03.
Step S03: The internal program of the microcomputer controller 22 is delayed by 50 ms, and the container cover closing process goes to the Step S04.
Step S04: The microcomputer controller 22 controls the motor driving circuit 24 to temporarily stop the power supply to the motor 23, and the container cover closing process goes to the Step S05.
Step S05: The microcomputer controller 22 controls the infrared pulse test circuit 21 to transmit the infrared pulse signal to the detecting zone D, and the container cover closing process goes to the Step S06.
Step S06: The microcomputer controller 22 determines whether there is an object in the detecting zone D. If at least an object is detected, the container cover closing process goes to the Step S09; If there is no object being detected, the container cover closing process goes to Step S07.
Step S07: The microcomputer controller 22 controls the motor driving circuit 24 to restore the power supply to the motor 23 and apply the positive (forward) voltage, and the container cover closing process goes to the Step S08.
Step S08: Determine whether the container cover 11 is closed in place, and if the container cover 11 is not closed in place, the container cover closing process returns the Step S03; If the container cover 11 is already closed in place, the container cover closing process performs the Step S10.
Step S09: The microcomputer controller 22 enters the container cover closing process. In the container cover closing process, the microcomputer controller 22 controls the motor driving circuit 24 to supply power to the motor 23 and apply the reverse voltage to the motor 23. Then the motor 23 rotates in the opposite direction and the container cover 11 is opened immediately.
Step S10: The microcomputer controller 22 controls the motor driving circuit 24 to stop supplying power to the motor 23, and the container cover closing process goes to the Step S11.
Step S11: The microcomputer controller 22 controls the induction trash container to enter a standby process.

Referring to FIG. 3, in the container cover closing process, the infrared pulse testing circuit 21 emits at least one infrared pulse signal every the first predetermined interval of time (embodied as 50 ms) to the detecting zone D, and the duration time of each emitting of the infrared pulse signal to the detecting zone D is the second predetermined interval of time (embodied as 0.3 ms). The second predetermined period of time is the closing action time of the container cover 11 is embodied as 3 seconds (3000 ms). Therefore, within the second predetermined period of time (the closing action time) of 3000 ms, a total of 60 infrared pulse signals are emitted to the detecting zone D, and thus the cumulative time of emitting infrared pulse signals to the detecting zone D=60 times×0.3 ms=18 ms, and the cumulative stopping time of the motor 23 of 18 ms which is much less than the time of 3000 ms of the slow closing process of the container cover 11, while the suspension time of the motor 23 of each cycle is 0.3 ms. Accordingly, the energized duty cycle of the motor 23=50 ms÷(50 ms+0.3 ms)=99.4%, the duty cycle of the motor 23 energized is as high as 99.4%. Since the rotor of the motor 23, the motor 23 and the container cover 11, and the speed reducer 25 are elements with weight inertia, the influence on the mechanical inertia of the container cover closing process is very small, and the continuity and smoothness of the container cover closing action can be guaranteed.

It is appreciated that through the configuration of the trash container cover control system 20 and method thereof disclosed above, even though the cumulative stop time of the motor 23 is arranged to be as less as possible to ensure continuity and smoothness of the container cover closing process, power consumption of the batter(ies) equipped in the induction trash container 1 for supplying electrical power to the motor 23 is reduced in consider to the numerous of the container cover closing processes being executed everyday.

As illustrated in FIG. 3, the pulse rectangular waveform for one complete closing cycle of the container cover 11 from starting to being closed in position is illustrated, wherein the rectangular waveform is expressed as a two-dimensional cartesian coordinate system defined by a pair of perpendicular axes, a horizontal axis and a vertical axis. The pulse rectangular waveform has two waveforms for designating two amplitudes on the vertical axis respectively, wherein one of the two amplitudes is defined as a voltage set at an upper portion of the pulse rectangular waveform and another of the two amplitudes is defined as a pulse of the emitting infrared set at a lower portion of the pulse rectangular waveform, and a time is defined on the horizontal axis for both the waveforms respectively, wherein variable symbols of the pulse rectangular waveform, including:

X is defined as a time taken for power supplying to the motor 23 in the upper portion of the pulse rectangular waveform and defined as an emitting time interval between infrared pulse signals emitting to the detecting zone D in the lower portion of the pulse rectangular waveform;

Y is defined as a time taken for no power supplying to the motor 23 in the upper portion of the pulse rectangular waveform and defined as a time taken from the infrared pulse signal emitted to the detecting zone D in the lower portion of the pulse rectangular waveform; and

Z is defined as a duration of a closing cycle of the container cover 11, wherein one closing cycle of container cover 11 is defined as a complete closing process of the container cover 11 from starting to being closed in position.

According to the preferred embodiment, the unit of time mentioned is millisecond (ms).

According to the preferred embodiment of the present invention, a number of times of emitting infrared pulse signals is A (=Z÷X), an accumulative time taken for the infrared pulse signals emitting to the detecting zone D is B ms (=A×Y) and a cycle of a duty ratio of the motor 23 powered is C % (=[X÷[X+Y]]×100).

In which, X or the emitting time interval between infrared pulse signals emitting to the detecting zone D is set in the range from 10 ms to 300 ms, and Y or the time taken from the infrared pulse signal emitted to the detecting zone D is set to be less than or equal to 0.3 ms, such that the number of times of emitting the infrared pulse signals is A or 400 (=4,000÷10), the accumulative time taken for the infrared pulse signals emitting to the detecting zone D is B ms or 120 ms (=400×0.3 ms) and the cycle of the duty ratio of the motor 23 powered is C % or 97% (=[10÷[10+0.3]]×100) when assume X is 10 ms, Y is 0.3 ms and Z is 4,000 ms (4 seconds).

The accumulative time taken for the infrared pulse signals emitting to the detecting zone D is 120 ms which is much less than the duration of one cycle of closing the sensing trash container cover 11, 4000 ms.

In other words, according to the preferred embodiment of the present invention, a number of times of emitting infrared pulse signals is A′ (=Z÷X′ or =Z÷[W %×Z]), an accumulative time taken for the infrared pulse signals emitting to the detecting zone D is B ms (=A′×Y) and a total cycle of a duty ratio of the motor 23 powered is C′% (=[[Z−B]÷Z]×100), wherein W % is defined as a predetermined percentage of the duration of a closing cycle of the container cover 11 such that the emitting time interval between infrared pulse signals emitting to a detecting zone D is X′ (=W %×Z).

In the alternative mode, when the infrared pulse signal is emitted to the detecting zone D every emitting time interval between 0.5% and 10% of total time taken for closing the container cover 11 during the time the container cover 11 is closed, Y or the time taken from the infrared pulse signal emitted to the detecting zone D is set to be less than or equal to 0.3 ms, such that the number of times of emitting infrared pulse signals is A′ or 200 (=3000÷[0.5%×3,000), the accumulative time taken for the infrared pulse signals emitting to the detecting zone D is B ms or 60 ms (=200×0.3 ms) and the total cycle of the duty ratio of the motor 23 powered is C′% or 98% (=[[3,000−60]÷3,000]×100) when assume W % is 0.5%, Y is 0.3 ms and Z is 3,000 ms (3 seconds).

Accordingly, the accumulative time taken for the infrared pulse signals emitting to the detecting zone D is 60 ms which is much less than the duration of one cycle of closing the container cover 11, 3000 ms.

It is worth mentioning that a duration that the power is supplied to the motor 23 in the upper portion of the pulse rectangular waveform is equal to the time interval between infrared pulse signals emitting to the detecting zone D in the lower portion of the pulse rectangular waveform. In the other words, the electric motor 23 is rotated in the forward direction for closing the container cover 11 when no infrared pulse signal is emitted to the detecting zone D.

Also, a duration that no power is supplied to the motor 23 in the upper portion of the pulse rectangular waveform is equal to the time taken from the infrared pulse signal emitted to the detecting zone D in the lower portion of the pulse rectangular waveform. In the other words, the power supply to the electric motor 223 is temporarily stopped when the infrared pulse signal is emitted to the detecting zone D.

According to the present invention, one closing cycle of the container cover 11 can be formed as a combination of a plurality of numbers for the emitting time interval between infrared pulse signals emitting to the detecting zone D and a plurality of numbers for no power supplying to the motor 23, wherein a duration of the one closing cycle of the container cover 11 is equal to a sum of an accumulative time taken for the plurality of numbers for the emitting time interval between infrared pulse signals emitting to the detecting zone D and an accumulative time taken for the plurality of numbers for no power supplying to the motor 23.

Also, one closing cycle of the container cover 11 can also be formed as a combination of a plurality of numbers for the infrared pulse signal emitted from the infrared pulse testing circuit 21 and a plurality of numbers for the power supplying to the motor 23, wherein the duration of the one closing cycle of the container cover 11 is equal to a sum of the accumulative time taken of the plurality of numbers for the infrared pulse signal emitting and the accumulative time taken of the plurality of numbers for the power supplying to the motor 23.

Accordingly, the accumulative time taken of the plurality of numbers for the infrared pulse signal emitting to the detecting zone D is much less than the accumulative time taken of the plurality of numbers for the power supplying to the motor 23.

Also, the time taken for power supplying to the motor 23 is actual closing time of the container cover 11 while the time taken for no power supplying to the motor 23 is actual stopping time for closing the container cover 11. In the other words, the duration of one closing cycle of the container cover 11 is formed as a sum of the accumulative time taken for a plurality of actual closing times of the container cover 11 and the accumulative time taken for a plurality of actual stopping time for closing the container cover 11.

In addition, the container cover 11 is opened immediately when an object is detected by the infrared pulse testing circuit 21 within the detecting zone D in any closing cycle of the container cover 11 so as to lead the cycle of closing the container cover 11 incomplete for closing the container cover 11 in position. A next closing cycle of the container cover 11 is resumed as per the pulse rectangular waveform when the closing of the container cover 11 is triggered.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A trash container cover control method of an induction trash container, comprising steps of:
(i) emitting infrared pulse signals intervally to a detecting zone of the induction trash container during a container cover closing process of the induction trash container to detect whether there is an object presence in the detecting zone; and
(ii) reopening the container cover of the induction trash container during the container cover closing process by actuating a motor of the induction trash container to reverse a rotation direction thereof to open the container cover once an object is detected within the detecting zone.

2. The trash container cover control method, as recited in claim 1, wherein the induction trash container comprises a container body, a container cover configured to be selectively operated between a close state and an open state with respect to the container body, a control system which includes the motor, an infrared pulse testing circuit, a microcomputer controller, a motor driving circuit, and a speed reducer, wherein when an object is detected in a predetermined detecting zone by the infrared pulse testing circuit, the container cover is actuated to a container cover opening process to open the container cover to an open state with respect to the container body by the motor, the motor driving circuit and the speed reducer, wherein after a first predetermined period of time, the container cover in open state is activated to a container cover closing process by the motor, the motor driving circuit and the speed reducer until the container cover is completely closed to a close state with respect to the trash container within a second predetermined period of time.

3. The trash container cover control method, as recited in claim 1, wherein the step (i) comprises steps of:
(a) during the container cover closing process, applying a positive voltage to the motor to drive the motor to rotate forward to drive the container cover to begin a container cover closing action to close;
(b) emitting an infrared pulse signal by the infrared pulse testing circuit to the detecting zone for every first predetermined interval of time by controlling the infrared pulse testing circuit by the microcomputer controller;
(c) maintaining each emitting of the infrared pulse signal for a second predetermined interval of time; and
(d) temporarily stopping a power supply to the motor by the motor driving circuit controlled by the microcomputer controller during the second predetermined interval of time;
wherein the step (ii) comprises steps of:
(e) if no object is detected in the detecting zone during the second predetermined interval of time, restoring the applying of the positive voltage to the motor by the motor driving circuit to drive the motor to rotate to drive the container cover to continue to complete the container cover closing action thereof until the container cover is in the close state;
(f) if an object is detected in the detecting zone during the second predetermined interval of time, applying a reverse voltage to the motor, to rotate in an opposite direction, to drive the container cover to re-open immediately to the open state; and
(g) after the first predetermined period of time, if no object is detected, repeating the steps (a) to (e) to close the trash container cover.

4. The trash container cover control method, as recited in claim 3, wherein a cumulative emission of infrared pulse signals to the detecting zone is less than a duration time of the container cover closing process.

5. The trash container cover control method, as recited in claim 3, wherein the first predetermined interval of time is set to a range of 10 ms to 300 ms, the second predetermined interval of time is smaller or equal to 0.3 ms and the second predetermined period of time is set to a range of 2 to 5 seconds.

6. The trash container cover control method, as recited in claim 4, wherein the first predetermined interval of time is set to a range of 10 ms to 300 ms, the second predetermined interval of time is smaller or equal to 0.3 ms and the second predetermined period of time is set to a range of 2 to 5 seconds.

7. The trash container cover control method, as recited in claim 2, wherein the step (i) comprises steps of:
(a) during the container cover closing process, applying a positive voltage to the motor to drive the motor to rotate forward to drive the container cover to begin a container cover closing action to close through the speed reducer;
(b) emitting an infrared pulse signal by the infrared pulse testing circuit to the detecting zone for every first predetermined interval of a total closing stroke of the closing container cover in the container cover closing process, from fully open to completely close, by controlling the infrared pulse testing circuit by the microcomputer controller;
(c) maintaining each emitting of the infrared pulse signal for a second predetermined interval of time; and
(d) temporarily stopping a power supply to the motor by the motor driving circuit controlled by the microcomputer controller during the second predetermined interval of time;
wherein the step (ii) comprises steps of:
(e) if no object is detected in the detecting zone during the second predetermined interval of time, restoring the applying of the positive voltage to the motor by the motor driving circuit to drive the motor to rotate to drive the container cover to continue to complete the container cover closing action thereof until the container cover is in the close state;
(f) if an object is detected in the detecting zone during the second predetermined interval of time, applying a reverse voltage to the motor, to rotate in an opposite direction, to drive the container cover to re-open immediately to the open state; and
(g) after the first predetermined period of time, if no object is detected, repeating the steps (a) to (e) to close the trash container cover.

8. The trash container cover control method, as recited in claim 7, wherein a cumulative emission of infrared pulse signals to the detecting zone is less than a duration time of the container cover closing process.

9. The trash container cover control method, as recited in claim 7, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.

10. The trash container cover control method, as recited in claim 8, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.

11. An induction trash container, comprising:
a container body;
a container cover configured to be selectively operated between a close state and an open state with respect to the container body; and
a control system, including:
a motor;
a speed reducer configured to couple with the motor so as to reduce a rotation speed of the motor to drive the container cover to selectively move upwardly to open the container body to the open state and downwardly to close the container body to the close state;
an infrared pulse testing circuit, configured to emit an infrared pulse signal into a detecting zone and receive reflecting infrared pulse signals reflected by an object in the detecting zone;
a motor driving circuit configured to electrically connected to the motor for applying a positive voltage to the motor to drive the motor to rotate in a forward direction and a reverse voltage to the motor to drive the motor to rotate in an opposite direction; and
a microcomputer controller configured to electrically connected with the infrared pulse testing circuit and the motor driving circuit for controlling operations of the infrared pulse testing circuit and the motor driving circuit;
wherein when an object is detected in the detecting zone by the infrared pulse testing circuit, the microcomputer controller is configured to activate the motor driving circuit to apply the reverse voltage to the motor to drive the motor to rotate in the opposite direction to actuate a container covering opening process to open the container cover to the open state with respect to the container body for a first predetermined period of time, wherein after the first predetermined period of time, the microcomputer controller controls the motor driving circuit to apply the positive voltage to the motor to drive the motor to rotate in the forward direction to actuate the container cover to a container cover closing process to close the container cover to the close state with respect to the container body;
wherein the infrared pulse testing circuit is controlled by the microcomputer controller to emit at least one infrared pulse signal to the detecting zone during the container cover closing process for every first predetermined interval of time, wherein each of the emitting of the infrared pulse signal is maintained for a second predetermined interval of time, and that the microcomputer controller controls the motor driving circuit to temporarily stop the power supply to the motor during the second predetermined interval of time;
wherein during the second predetermined interval of time, if the object is detected in the detecting zone, the motor driving circuit is controlled by the microcomputer controller to apply the reverse voltage to the motor to rotate in the opposite direction to drive the container cover to re-open immediately for the first predetermined period of time, and then the microcomputer controller controls the motor driving circuit to perform the container cover closing process by applying the positive voltage to the motor to drive the motor to rotate in the forward direction to close the container cover with respect to the container body;
wherein if no object is detected in the detecting zone during the second predetermined interval of time, the motor driving circuit is controlled by the microcomputer controller to apply the positive voltage to the motor to drive the motor to rotate in the forward direction to drive the container cover to continue to complete the container cover closing action thereof until the container cover is closed in the close state.

12. The induction trash container, as recited in claim 11, wherein a cumulative emission of infrared pulse signals to the detecting zone is less than a duration time of the container cover closing process.

13. The induction trash container, as recited in claim 11, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.

14. The induction trash container, as recited in claim 12, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.

15. A trash container cover control system of an induction trash container comprising a container body and a container cover configured to be selectively operated between a close state and an open state with respect to the container body, where the trash container cover control system comprises:
a motor;
a speed reducer configured to couple with the motor so as to reduce a rotation speed of the motor to drive the container cover to selectively move upwardly to open the container body to the open state and downwardly to close the container body to the close state;
an infrared pulse testing circuit, configured to emit an infrared pulse signal into a detecting zone and receive reflecting infrared pulse signals reflected by an object in the detecting zone;
a motor driving circuit configured to electrically connected to the motor for applying a positive voltage to the motor to drive the motor to rotate in a forward direction and a reverse voltage to the motor to drive the motor to rotate in an opposite direction; and
a microcomputer controller configured to electrically connected with the infrared pulse testing circuit and the motor driving circuit for controlling operations of the infrared pulse testing circuit and the motor driving circuit.

16. The trash container cover control system, as recited in claim 15, wherein when an object is detected in the detecting zone by the infrared pulse testing circuit, the microcomputer controller is configured to activate the motor driving circuit to apply the reverse voltage to the motor to drive the motor to rotate in the opposite direction to actuate a container covering opening process to open the container cover to the open state with respect to the container body for a first predetermined period of time, wherein after the first predetermined period of time, the microcomputer controller controls the motor driving circuit to apply the positive voltage to the motor to drive the motor to rotate in the forward direction to actuate the container cover to a container cover closing process to close the container cover to the close state with respect to the container body;
wherein the infrared pulse testing circuit is controlled by the microcomputer controller to emit at least one infrared pulse signal to the detecting zone during the container cover closing process for every first predetermined interval of time, wherein each of the emitting of the infrared pulse signal is maintained for a second predetermined interval of time, and that the microcomputer controller controls the motor driving circuit to temporarily stop the power supply to the motor during the second predetermined interval of time;
wherein during the second predetermined interval of time, if the object is detected in the detecting zone, the motor driving circuit is controlled by the microcomputer controller to apply the reverse voltage to the motor to rotate in the opposite direction to drive the container cover to re-open immediately for the first predetermined period of time, and then the microcomputer controller controls the motor driving circuit to perform the container cover closing process by applying the positive voltage to the motor to drive the motor to rotate in the forward direction to close the container cover with respect to the container body;
wherein if no object is detected in the detecting zone during the second predetermined interval of time, the motor driving circuit is controlled by the microcomputer controller to apply the positive voltage to the motor to drive the motor to rotate in the forward direction to drive the container cover to continue to complete the container cover closing action thereof until the container cover is closed in the close state.

17. The trash container cover control system, as recited in claim 16, wherein a cumulative emission of infrared pulse signals to the detecting zone is less than a duration time of the container cover closing process.

18. The trash container cover control system, as recited in claim 16, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.

19. The induction trash container, as recited in claim 17, wherein the first predetermined interval of the total closing stroke is set to a range of time is set to a range of 0.5%˜10%, the second predetermined interval of time is smaller or equal to 0.3 ms and the second predetermined period of time is set to a range of 2 to 5 seconds.
